(19) United States
(12) Patent Application Publication
(10) Pub. No.: US 2022/0389210 A1
(43) Pub. Date: Dec. 8, 2022

(54) Crosslinkable and foamable composition, foam obtained by the same, composition for foaming and use thereof

(71) Applicant: LCY CHEMICAL CORP., Kaohsiung City (TW)

(72) Inventors: Richard Tien-Hua CHOU, Hockessin, DE (US); Yu-Yan LI, Kaohsiung City (TW); Wei-Chin HUANG, Kaohsiung City (TW); You-Min WANG, Kaohsiung City (TW); Chi-Jui HSIEH, Kaohsiung City (TW)

(21) Appl. No.: 17/826,748

(22) Filed: May 27, 2022

Related U.S. Application Data
(60) Provisional application No. 63/197,548, filed on Jun. 7, 2021.

(51) Int. Cl. C08L 53/02; C08J 9/10

(52) U.S. Cl. CPC C08L 53/02; C08J 9/103; C08J 2353/02; C08J 2423/08

(57) ABSTRACT

A crosslinkable and foamable composition is provided, which comprises a hydrogenated styrenic diblock copolymer, a free radical initiator and a foaming agent, wherein the hydrogenated styrenic diblock copolymer comprises: a first block comprising an isoprene unit; and a second block comprising a styrene unit, wherein the hydrogenated styrenic diblock copolymer comprises 10 to 60 wt % of the styrene unit, 50 mol % or more of the isoprene unit is hydrogenated, and the hydrogenated styrenic diblock copolymer has a weight average molecular weight of 30000 to 200000. In addition, a foam obtained by crosslinking and foaming the aforesaid crosslinkable and foamable composition is also provided.

### CROSS REFERENCE TO RELATED APPLICATION

This application claims the benefit of filing date of U.S. Provisional Application Ser. No. 63/197,548, filed Jun. 7, 2021 under 35 USC § 119(e)(1).

### BACKGROUND

### 1. Field

The present disclosure relates to a crosslinkable and foamable composition, and a foam obtained by crosslinking and foaming the aforesaid crosslinkable and foamable composition.

### 2. Description of Related Art

Various materials are used for making shoe soles, and the most popular one is rubber. The rubber sole footwear has unmatched wear resistance as well as greatly extended contraction in all seasons, such as 20 walking on a wet pavement or on snow-covered streets. Thermoplastic materials are also being used for footwear outsoles. For example, the outsole made of PVC is flexible and cheap but can be slippery.

Thermoplastic elastomer (TPE) compositions are based on materials, which behave like cured rubbers at room temperature, but can be melt 25 processed at elevated temperatures. The TPE materials most frequently used in the production of shoe soles are styrenic block copolymers (SBC), such as styrene-butadiene-styrene (SBS) triblock copolymers, and thermoplastic polyurethane (TPU).

For attaining light weight, foams, such as foams based on ethylene-vinyl acetate (EVA), are also used as footwear outsole. EVA is widely used to fabricate foam products mainly used as midsole part in footwear applications. For outsole usage, however, there are some deficiencies for EVA foam, such as poor slip resistance, which prevents EVA foam from gaining broad usage as footwear outsole. Blends of varied materials are often used to prepare foams with improved anti-slip properties. For example, CN104693564B discloses an expandable composition comprising bromobutyl (BIIR), EVA, and low density polyethylene (LDPE) for making foams for shoe soles with high damping and anti-slip performance.

Among TPE materials, SBC, such as SBS and SEBS (hydrogenated SBS), is the only category that can be fabricated into foams of lightweight in a conventional footwear foam process involving first incorporating peroxide initiators and chemical blowing agents at a temperature of about 120° C. or less, and then molding in a mold for crosslinking the foam composition and then foaming at a temperature of about from 140° C. to 190° C. As SBC materials have overall good abrasion resistance and anti-slip resistance as well, foams mainly comprising SBC are being developed into foams for shoe soles. For example, CN106349633B discloses an expandable composition comprising mainly SEBS, and a minor portion of LDPE, olefin block copolymer (OBC), and styrene-butadiene rubber (SBR), for making foams with good dry and wet antiskid property. Also for example, CN102888067B discloses an elastic foamed material of good elasticity and anti-slip property comprising mainly SEBS, and including PP (polypropylene), EVA, inorganic filler, and a small amount of filling oil.

In light of the trend of using lightweight foam as ground contact outsole, there is a continued need to develop novel foam resins for producing foam with enhanced slip resistance performance and overall balanced mechanical properties suitable to be used as outsole part of footwear. Also, in light of the prevailing position of EVA foam for footwear usage, there is a continued need to modify EVA foam for enhancing slip resistance performance.

### SUMMARY

The objectives of the present disclosure are twofold. The first objective is to develop a styrenic block copolymer resin, which based foam has balanced mechanical properties, most specifically excellent anti-slip property that is important for footwear outsole, and that the foam is produced involving a step of incorporating free radical initiators and foaming agents into the crosslinkable and foamable composition at a temperature of about 120° C. or lower, and then a step of injecting molding the crosslinkable and foamable composition in an injection mold for peroxide crosslinking and foaming agent decomposition at a temperature from about 150° C. to 200° C.

The second objective is to develop a styrenic block copolymer resin, which can be blended with ethylene copolymers, such as EVA, to be made into foam, which foam attains foam properties manifesting the merits of both materials, most especially showing excellent anti-slip property important for footwear outsole application.

While not bounded by theory, the present disclosure is based on the discovery that a hydrogenated styrene-isoprene diblock copolymer is most suitable for attaining the objectives of the present disclosure as described above. The foam comprising the hydrogenated styrene-isoprene diblock copolymer attains desirable anti-slip properties suitable to be used as shoe outsoles.

Furthermore, the present disclosure is based on the discovery that the polymer structure of the hydrogenated styrene-isoprene diblock copolymer is most suited in the foam compounding and injection processes of incorporating peroxide initiators and foaming agents at a temperature of about 120° C. or lower, and then peroxide crosslinking of the compound in a mold at temperatures of about 150° C. to 200° C.

The following serves to illustrate further in details.

In general practice, SBC is produced by anionic polymerization to first prepare a diblock copolymer of one hard styrene block and one soft block, such as butadiene or isoprene block, and then via either coupling or continued polymerization to form linear A-B-A type or star multi-block type block copolymer. Hydrogenated SBC, such as SEBS, further enhances the mechanical properties and weatherability. SBC block copolymers as a category of TPE is widely used for many applications including footwear foam. Hydrogenated SBC, such as hydrogenated SEBS is preferred for footwear foam applications. Partially hydrogenated SEBS is most preferred for footwear foam applications as the residual unsaturation in the soft block facilitates the peroxide crosslinking.

In A-B type styrenic diblock copolymer, the hard styrene blocks are not tied up to form a physical crosslinking like a multi-block copolymer. It does not have the characteristics of a thermoplastic elastomer, such as elasticity. In short, the styrenic diblock copolymer is not considered a thermoplastic elastomer, and it has limited commercial usage. For example, very few commercial products of styrenic diblock copolymers are available from global SBC producers. Styrenic diblock copolymers are most used for adhesive, coating, or modifiers, where mechanical strength and elasticity are not of primary importance. Unexpectedly and surprisingly, it was found that the A-B type hydrogenated styrene-isoprene diblock copolymer can be compounded well, and foamed into foam with superior anti-slip performance.

It is of benefits to further point out the impact of structural difference between a triblock copolymer and a diblock copolymer on peroxide curing, a key process for enhancing the melt strength for foaming. For triblock SEBS, a chemical crosslinking by peroxide crosslinking is introduced at the melt stage into the pre-existing physical crosslinking of SEBS. On the other hand, the styrenic diblock copolymer is free of the pre-existing physical crosslinking network. In peroxide crosslinking, a newly formed crosslinking by peroxide crosslinking is formed, and all the loose styrene blocks are tied up in the crosslinking. In short, the peroxide crosslinking of a styrenic diblock copolymer serves not only to provide a chemical crosslinking via peroxide crosslinking, also to form a physical crosslinking network as a consequence of the crosslinking. It is still an unexpected surprise that the peroxide crosslinking transforms a styrene-isoprene diblock copolymer into a suitable foam resin for attaining superior slip resistance property.

In addition, a styrene-isoprene diblock copolymer is found to have good compatibility with other ethylene copolymers, such as EVA, which is of importance in producing foam comprising of dissimilar polymers. It is known that A-B type diblock copolymer has a better self-assembly capability originated from the thermodynamic incompatibility between A-B two blocks of the copolymer. And this is the reason that A-B diblock copolymer is often used as compatibilizer of two dissimilar polymers.

According to the objectives of the present disclosure, the present disclosure provides a crosslinkable and foamable composition, a foam obtained by crosslinking and foaming the same and the preparation thereof as described below.

The present disclosure provides a crosslinkable and foamable composition, which comprises a hydrogenated styrenic diblock copolymer, a free radical initiator and a foaming agent. The hydrogenated styrenic diblock copolymer comprises: a first block comprising an isoprene unit; and a second block comprising a styrene unit. Herein, the hydrogenated styrenic diblock copolymer comprises 10 to 60 wt % of the styrene unit, 50 mol % or more of the isoprene unit is hydrogenated, and the hydrogenated styrenic diblock copolymer has a weight average molecular weight of 30000 to 200000. The present disclosure also provides a foam or a footwear component obtained by crosslinking and foaming the aforesaid crosslinkable and foamable compositions. Thus, the obtained foam or the obtained footwear component comprises the hydrogenated styrenic diblock copolymer, and has the features of the aforesaid hydrogenated styrenic diblock copolymer.

The present disclosure also provides another crosslinkable and foamable composition, which comprises a hydrogenated styrenic diblock copolymer, an ethylene copolymer, a free radical initiator and a foaming agent. The features of the hydrogenated styrenic diblock copolymer are as described above and are not described again. In addition, a weight ratio of the ethylene copolymer to the hydrogenated styrenic diblock copolymer is from 50/50 to 95/5. The present disclosure also provides a foam or a footwear component obtained by crosslinking and foaming the aforesaid crosslinkable and foamable compositions. Thus, the obtained foam or the obtained footwear component comprises the hydrogenated styrenic diblock copolymer and the ethylene copolymer, and has the features of the aforesaid hydrogenated styrenic diblock copolymer and the weight ratio of the ethylene copolymer to the hydrogenated styrenic diblock copolymer.

The present disclosure further provides a composition for foaming, which comprises a hydrogenated styrenic diblock copolymer. The features of the hydrogenated styrenic diblock copolymer are as described above and are not described again. In addition, the present disclosure also provides a use of the aforesaid composition for preparing a foam.

The details of one or more embodiments of the disclosure are set forth in the description below. Other features, objects, and advantages of the disclosure will be apparent from the description and from the claims.

### DETAILED DESCRIPTION

Different embodiments of the present disclosure are provided in the following description. These embodiments are meant to explain the technical content of the present disclosure, but not meant to limit the scope of the present disclosure. A feature described in an embodiment may be applied to other embodiments by suitable modification, substitution, combination, or separation.

It should be noted that, in the present specification, when a component is described to have an element, it means that the component may have one or more of the elements, and it does not mean that the component has only one of the element, except otherwise specified.

In the present specification, except otherwise specified, the feature A “or” or “and/or” the feature B means the existence of the feature A, the existence of the feature B, or the existence of both the features A and B. The feature A “and” the feature B means the existence of both the features A and B. The term “comprise(s)”, “comprising”, “include(s)”, “including”, “have”, “has” and “having” means “comprise(s)/comprising but is/are/being not limited to”.

In the present disclosure, except otherwise specified, the terms “almost”, “about” and “approximately” usually mean the acceptable error in the specified value determined by a skilled person in the art, and the error depends on how the value is measured or determined. In some embodiments, the terms “almost”, “about” and “approximately” mean within 1, 2, 3 or 4 standard deviations. In some embodiments, the terms “almost”, “about” and “approximately” mean within ±20%, within ±15%, within ±10%, within ±9%, within ±8%, within ±7%, within ±6%, within ±5%, within ±4%, within ±3%, within ±2%, within ±1%, within t0.5%, within +0.05% or less of a given value or range. The quantity given here is an approximate quantity, that is, without specifying “almost”, “about” and “approximately”, it can still imply “almost”, “about” and “approximately”. In addition, the terms “in a range of a first value to a second value”, “from a first value to a second value” and the like mean the said range comprises the first value, the second value and other values between the first value and the second value.

In addition, the features in different embodiments of the present disclosure can be mixed to form another embodiment.

In some embodiments, the crosslinkable and foamable composition may comprise a hydrogenated styrenic diblock copolymer, a free radical initiator and a foaming agent. The hydrogenated styrenic diblock copolymer may comprise: a first block comprising an isoprene unit; and a second block comprising a styrene unit. Herein, the hydrogenated styrenic diblock copolymer comprises 10 to 60 wt % of the styrene unit, 50 mol % or more of the isoprene unit is hydrogenated, and the hydrogenated styrenic diblock copolymer has a weight average molecular weight of 30000 to 200000.

In some embodiments, the crosslinkable and foamable composition may comprise a hydrogenated styrenic diblock copolymer, an ethylene copolymer, a free radical initiator and a foaming agent. The features of the hydrogenated styrenic diblock copolymer are as described above and are not described again. In addition, a weight ratio of the ethylene copolymer to the hydrogenated styrenic diblock copolymer may be from 50/50 to 95/5.

In some embodiments, a foam obtained by crosslinking and foaming any of the aforesaid crosslinkable and foamable compositions is provided.

In some embodiments, a footwear component obtained by crosslinking and foaming any of the aforesaid crosslinkable and foamable compositions is provided.

In some embodiments, the composition for foaming may comprise a hydrogenated styrenic diblock copolymer. The features of the hydrogenated styrenic diblock copolymer are as described above and are not described again.

In some embodiments, a use of the aforesaid composition for foaming is applied for preparing a foam.

Hereinafter, the components of the aforesaid crosslinkable and foamable composition, the foam or the footwear component obtained by crosslinking and foaming any of the aforesaid crosslinkable and foamable compositions, and the preparation thereof are described in detail. In addition, the component of the aforesaid composition for foaming is also described in detail.

### Hydrogenated Styrenic Diblock Copolymer

The hydrogenated styrenic diblock copolymer of the present disclosure is a diblock copolymer comprising a first block comprising an isoprene unit, and a second block comprising a styrene unit.

In some embodiments, the hydrogenated styrenic diblock copolymer may comprise about 10 to 60 wt % of the styrene unit based on the total weight of the hydrogenated styrenic diblock copolymer. When the crosslinked foam is prepared by the crosslinkable and foamable composition with the content of the styrene unit less than 10 wt %, the mechanical properties (for example, split tear) of the crosslinked foam is poor. When the crosslinked foam is prepared by the crosslinkable and foamable composition with the content of the styrene unit more than 60 wt %, the impact resilience or the compression set of the crosslinked foam is poor.

In some embodiments, for the purpose of making a crosslinked foam with balance mechanical properties, the hydrogenated styrenic diblock copolymer may comprise about 10 to 50 wt % of the styrene unit based on the total weight of the hydrogenated styrenic diblock copolymer, and the rest of the hydrogenated styrenic diblock copolymer is the conjugated diene monomer unit. Within this range, the crosslinked foam can be expected to have a balanced mechanical properties and an excellent anti-slip property. In some embodiments, the hydrogenated styrenic diblock copolymer may comprise about, for example, 15 to 50 wt %, 20 to 50 wt %, 20 to 45 wt %, 20 to 40 wt % or 22 to 40 wt/o of the styrene unit, and the rest of the hydrogenated styrenic diblock copolymer is the conjugated diene monomer unit.

In some embodiments, about 50 mol % or more of the isoprene unit of the styrenic diblock copolymer is hydrogenated after hydrogenation. In some embodiments, about 50 to 100 mol % of the isoprene unit is hydrogenated after hydrogenation. In some embodiments, about, for example, 55 to 100 mol %, 60 to 100 mol %, 65 to 100 mol %, 70 to 100 mol %, 75 to 100 mol % or 75 to 99 mol % of the isoprene unit is hydrogenated after hydrogenation. If the hydrogenation degree is less than 50 mol %, it is difficult to be manufactured due to being too sticky to metal surface.

In some embodiments, the hydrogenated styrenic diblock copolymer may have a weight average molecular weight of about 30000 to 200000. If the weight average molecular weight of the hydrogenated styrenic diblock copolymer is less than 30000, the hydrogenated styrenic diblock copolymer renders poor mechanical properties of the resulting foam. If the weight average molecular weight of the hydrogenated styrenic diblock copolymer is more than 200000, the hydrogenated styrenic diblock copolymer is difficult to process.

In some embodiment, the hydrogenated styrenic diblock copolymer may have a weight average molecular weight of about, for example, 40000 to 200000, 50000 to 200000, 60000 to 200000, 70000 to 200000, 70000 to 190000, 70000 to 180000, 70000 to 170000, 70000 to 160000, 70000 to 150000, 70000 to 140000, 80000 to 140000, 80000 to 130000, 90000 to 130000 or 100000 to 130000.

In some embodiments, the first block may be a polymer block of an isoprene unit. In some embodiments, the first block may be a polymer block of an isoprene unit and a butadiene unit, wherein a content of the butadiene unit is less than or equal to 15 wt % based on a total weight of the first block.

In some embodiments, the second block may be a polymer block of a styrene unit. In some embodiments, the second block may be a polymer block of a styrene unit and a conjugated diene monomer unit, wherein a content of the conjugated diene monomer unit may be less than or equal to 15 wt % based on a total weight of the second block. In some embodiments, the content of the conjugated diene monomer unit may be in the range of about 0.5 to 15 wt/o, 0.5 to 14 wt %, 0.5 to 13 wt %, 0.5 to 12 wt %, 0.5 to 11 wt % or 0.5 to 10 wt % based on a total weight of the second block. Herein, the conjugated diene monomer unit may be a butadiene unit, an isoprene unit, or a mixture thereof. In some embodiments, the second block may be a polymer block of a styrene unit and a butadiene unit, wherein a content of the butadiene unit may be less than or equal to 10 wt % based on a total weight of the second block. When the second block is a polymer block comprising a small amount (less than or equal to 15 wt/o) of the conjugated diene monomer unit, the flowability of the hydrogenated styrenic diblock copolymer may be improved.

In some embodiments, the first block may be a polymer block of an isoprene unit and the second block may be a polymer block of a styrene unit.

In some embodiments, the first block may be a polymer block of an isoprene unit and a butadiene unit, wherein a content of butadiene may be less than or equal to 15 weight % based on a total weight of the first block, and the second block may be a polymer block of a styrene unit.

In some embodiments, the first block may be a polymer block of an isoprene unit, and the second block may be a polymer block of a styrene unit and a conjugated diene monomer unit, wherein the conjugated diene monomer unit may be a butadiene unit, an isoprene unit, or a mixture thereof, and a content of the conjugated diene monomer unit may be less than or equal to 15 wt % based on a total weight of the second block.

In some embodiments, the first block may be a polymer block of an isoprene unit and a butadiene unit, wherein a content of the butadiene unit may be less than or equal to 15 wt % based on a total weight of the first block, and the second block may be a polymer block of a styrene unit and a conjugated diene monomer unit, wherein the conjugated diene monomer unit may be a butadiene unit, an isoprene unit, or a mixture thereof, and a content of the conjugated diene monomer unit may be less than or equal to 15 wt % based on a total weight of the second block.

In some embodiments that, for example, when the first block and/or the second block comprises the isoprene unit, a 3,4-vinyl bond content in the isoprene unit may be in the range of about 5 to 40 mol % prior to hydrogenation. In some embodiments, the 3,4-vinyl bond content in the isoprene unit may be in the range of about, for example, 5 to 35 mol %, 5 to 30 mol %, 5 to 25 mol %, 5 to 20 mol % or 5 to 15 mol % prior to hydrogenation.

In some embodiments, for example, when the first block and/or the second block comprises the butadiene unit, a 1,2-vinyl bond content in the conjugated diene monomer unit (i.e. the butadiene) may be in the range of about 5 to 40 mol % prior to hydrogenation.

Herein the term “vinyl bond” is used to describe the polymer product that is made when 1,3-butadiene is polymerized via a 1,2-addition mechanism and isoprene is polymerized via a 3,4-addition mechanism.

The result is a mono-substituted olefin group pendant to the polymer backbone, a vinyl group. In the case of anionic polymerization of isoprene, insertion of the isoprene via a 3,4-addition mechanism affords a germinal dialkyl C═C moiety pendant to the polymer backbone. The effects of the 3,4-addition polymerization of isoprene on the final properties of the block copolymer will be similar to those from 1,2-addition of butadiene.

The method for manufacturing the styrenic diblock copolymer prior to hydrogenation of the present disclosure is not particularly limited, and any known method can be used. Among the polymerization method, living anionic polymerization may be used, performed in a hydrocarbon solvent, and initiated by an organoalkali metal compound. For example, the above-mentioned polymer synthesis steps are clearly described in U.S. Pat. No. 7,332,542. The hydrocarbon solvent is not particularly limited, and any known solvent can be used. For instance, the hydrocarbon solvent may include aliphatic hydrocarbons such as n-hexane; alicyclic hydrocarbons such as cyclohexane; or aromatic hydrocarbons such as xylene. The above-mentioned hydrocarbon solvents can be used singly or in combinations of two or more.

The initiator is not particularly limited, and initiators that are known to have anionic polymerization activity with vinyl aromatic monomers, such as styrene, and conjugated diene monomers, such as isoprene, can be applied such as aliphatic hydrocarbon alkali metal compounds, aromatic hydrocarbon alkali metal compounds, and organic amino alkali metal compounds. Alkali metals used as the initiator may include lithium, sodium, and potassium. In some embodiments, the initiator may be aliphatic hydrocarbon alkali metal, such as n-butyl lithium.

The polymerization process of preparing the styrenic diblock copolymer may be carried out similar to those used for anionic polymerizations. The polymerization may be carried out at a temperature from around 0° C. to around 180° C., more preferably from about 30° C. to about 150° C., and the most preferably from about 30° C. to about 90° C. It is carried out in an inert atmosphere preferably nitrogen, and may also be accomplished under pressure within the range of from about 0.5 to about 10 bars. The polymerization process generally requires less than 12 hours, depending upon the temperature, the concentration of the monomer components, the molecular weight of the polymer, etc.

The hydrogenation of the styrenic diblock copolymer can be carried out in known hydrogenation processes. For example, such hydrogenation has been accomplished using methods such as reported in U.S. Pat. Nos. 3,595,942 and 3,700,633. These methods of hydrogenation employ suitable catalysts. This mentioned catalyst may comprise a Group VIII metal such as nickel or cobalt which is combined with a suitable reducing agent such as an aluminum alkyl or hydride of a metal selected from Groups I-A, II-A and III-B of the Periodic Table of the Elements, particularly lithium, magnesium or aluminum.

The hydrogenation process is not particularly limited, but the hydrogenation is typically carried out at a temperature from 0° C. to 180° C., and more preferably from 30° C. to 150° C. The hydrogen pressure used in this process is not particularly limited, but is typically from 0.1 to 20 MPa, 0.2 to 15 MPa or 0.3 to 5 MPa. The reaction time is typically from 1 minute to 10 hours or from 10 minutes to 5 hours.

The hydrogenation process may be performed by a batch process, continuous process, or a combination thereof. If it is necessary, the catalyst residue may be removed. The hydrogenated polymer may be isolated by pouring into hot water while stirring, and the organic solvent may be removed by steam stripping.

A typical synthesis method of preparing the hydrogenated styrene-isoprene diblock copolymer is simply described here. First, cyclohexane (as the solvent) and n-butyllithium (as the initiator) are charged into a reactor equipped with a heater and a stirrer. Secondly, isoprene is added into the solvent to carry out the anionic polymerization. Thirdly, styrene is added into the reactor, and the reaction mixture is further polymerized to form a styrene-isoprene diblock copolymer structure. This block copolymer is then hydrogenated in a pressure vessel using a nickel-2-ethylhexanoate/TEAL catalyst and hydrogen gas. After about 50 mol % or more of the isoprene units is hydrogenated, the hydrogenation reaction is terminated. The obtained styrene-isoprene diblock copolymer is washed with hot acidic water to remove residual catalyst.

In some embodiments, the microstructure of the isoprene segment of the hydrogenated styrenic diblock copolymer, such as vinyl bond content and the styrene content prior to hydrogenation, and the degree of hydrogenation after hydrogenation, may be measured using proton nuclear magnetic resonance (¹H-NMR) method. Moreover, the weight average molecular weight may be determined by gel permeation chromatography (GPC).

Moreover, for the purpose of adjusting the foam properties, the hydrogenated styrene-isoprene diblock copolymer of the present disclosure may contain a hydrogenated styrenic multi-block copolymer, such as SEPS triblock, of similar composition up to 20 wt. %. The styrene-isoprene multi-block copolymer may have the styrene content of 10 to 40 wt %, a weight average molecular weight of about 30000 to 80000, the 3,4-vinyl bond content of 10 to 30 mol % of the isoprene units prior to hydrogenation, and the hydrogenation of 60 to 95 mole % of the isoprene units. The exact weight ratio of the hydrogenated styrenic multi-block copolymer to the hydrogenated styrenic diblock copolymer is dependent on the foam process, and the foam properties required for end applications.

### Ethylene Copolymer

In some embodiments of the present disclosure, the crosslinkable and foamable composition may comprise the aforesaid hydrogenated styrenic diblock copolymer and an ethylene copolymer.

In some embodiments, a weight ratio of the ethylene copolymer to the hydrogenated styrenic diblock copolymer may be from 50/50 to 95/5. In some embodiments, the weight ratio of the ethylene copolymer to the hydrogenated styrenic diblock copolymer may be from, for example, 50/50 to 90/10, 60/40 to 90/10, 65/35 to 90/10 or 70/30 to 90/10.

In the present disclosure, the ethylene copolymer is not particularly limited, and a known ethylene copolymer can be used. For instance, the suitable ethylene copolymer may comprise polyethylene (PE), an ethylene-vinyl acetate copolymer (EVA) obtainable by copolymerization of ethylene and vinyl acetate, an ethylene-α-olefin-based copolymer obtainable by random or block copolymerization of ethylene and C₃₋₁₀ α-olefins, or a combination thereof.

In some embodiments, the ethylene copolymer may be the polyethylene, which may be high density polyethylene, low density polyethylene or a combination thereof.

In some embodiments, the ethylene copolymer may be the ethylene-vinyl acetate copolymer, and a content of vinyl acetate is in a range of about 15 to 40 wt % based on a total weight of the ethylene copolymer. In some embodiments, the content of vinyl acetate may be in a range of about 15 to 35 wt %, 15 to 30 wt %, 18 to 30 wt % or 20 to 30 wt %, based on a total weight of the ethylene copolymer.

In some embodiments, the ethylene copolymer may be the ethylene-α-olefin-based copolymer, wherein the α-olefin may include 1-butene, 1-pentene, 1-hexene, 1-octene, the like or a combination thereof.

### Free Radical Initiator

In some embodiments of the present disclosure, the crosslinkable and foamable composition may further comprise a free radical initiator. Herein, the free radical initiator used for crosslinking the crosslinkable and foamable composition is not particularly limited, and any known free radical initiator may be used.

In some embodiments, the free radical initiator may be an organic peroxide.

In some embodiments, the organic peroxide may be selected from the group consisting of dicumyl peroxide, 2,5-dimethyl-2,5-di-(t-butylperoxy)hexane, bis(1-(tert-butylperoxy)-1-methylethyl)-benzene and a combination thereof. In some embodiments, the organic peroxide may be bis(1-(tert-butylperoxy)-1-methylethyl)-benzene. However, the present disclosure is not limited thereto.

The used amount of the free radical initiator is not particularly limited. In some embodiments, the used amount of the free radical initiator may be from about 0.01 to 10 wt %, 0.01 to 9 wt %, 0.01 to 8 wt %, 0.01 to 7 wt %, 0.01 to 6 wt %, 0.01 to 5 wt %, 0.01 to 4 wt %, 0.05 to 4 wt %, 0.05 to 3 wt %, 0.1 to 3 wt %, 0.1 to 2.5 wt %, 0.1 to 2 wt %, 0.1 to 1.5 wt % or 0.1 to 1 wt % based on the total weight of the crosslinkable and foamable composition.

### Foaming Agent

In some embodiments of the present disclosure, the crosslinkable and foamable composition may further comprise a foaming agent. Herein, the foaming agent is not particularly limited, and any known foaming agent may be used. For example, the foaming agent may be a chemical foaming agent, a physical foaming agent or a combination thereof.

In some embodiment, the foaming agent is a chemical foaming agent.

In some embodiments, the foaming agent may comprise an organic forming agent such as azodicarbonamide (ADCA), bis(1-(tert-butylperoxy)-1-methylethyl)-benzene, 4,4′-oxybis(benzenesulfonylhydrazide), p-toluenesulfonyl semicarbazide, N, N′-dinitrosopentamethylenetetramine, diphenylsulfone-3,3′-disulfonyl hydrazide (DPSDSH), trihydraznotriazine or combination thereof; or an inorganic type thermal decomposable foaming agent, such as sodium hydrogencarbonate, ammonium hydrogencarbonate, sodium carbonate, ammonium carbonate or a combination thereof. Herein, the organic forming agent and the inorganic type thermal decomposable foaming agent may be used alone or together. In some embodiments, the foaming agent may be azodicarbonamide. However, the present disclosure is not limited thereto.

The used amount of the foaming agent is not particularly limited. In some embodiments, the used amount of the foaming agent may be from about 0.5 to 10 wt %, 0.5 to 9 wt %, 0.5 to 8 wt %, 0.5 to 7 wt %, 0.5 to 6 wt %, 0.5 to 5 wt % or 1 to 5 wt % based on the total weight of the crosslinkable and foamable composition.

In some embodiments, the foaming agent may be a physical foaming agent, such as nitrogen, carbon dioxide, alkanes, cycloalkanes, dialkyl ethers, cycloalkylene ethers, fluoroalkanes, hydrofluoroolefins, hydrochlorofluoroolefins, or a combination thereof.

### Other Additives

In some embodiments of the present disclosure, if necessary, in addition to the above-mentioned components, the crosslinkable and foamable composition may further selectively comprise other additives, for example, a crosslinking co-agent, an organometallic compound, fillers, a thermal stabilizer, a weather stabilizer, pigments, etc. However, the present disclosure is not limited thereto.

In some embodiments of the present disclosure, for the purpose of accelerating the rate of crosslinking reaction, the crosslinkable and foamable composition may further comprise a crosslinking co-agent. For example, the crosslinking co-agent may comprise, but is not limited to, triallyl isocyanurate, triallyl cyanurate, ethylene glycol dimethacrylate, vinyl butyrate, etc.

In some embodiments of the present disclosure, for the purpose of making crosslinked foam pores be finer or more uniform, the crosslinkable and foamable composition may further comprise an organometallic compound. For example, the organometallic compound may comprise, but is not limited to, zinc diacrylate or zinc dimethacrylate, which can also serve as a crosslinking co-agent.

In some embodiments of the present disclosure, for the purpose of cost-saving, adjusting hardness or modulus, or nucleation, the crosslinkable and foamable composition may further comprise fillers. For example, the fillers may comprise, but are not limited to, clay, silicon dioxide, talc, titanium dioxide, zinc oxide, calcium carbonate, etc.

In some embodiments of the present disclosure, for the purpose of enhancing the foam product durability, the crosslinkable and foamable composition may further comprise a thermal stabilizer, a weather stabilizer or a combination thereof. For example, the thermal stabilizer may comprise, but is not limited to, the phosphorus-based type thermal stabilizer such as Irgafos 168. For example, the weather stabilizer may comprise, but is not limited to, the hindered phenol-based type weather stabilizer such as pentaerythritol tetrakis[3-[3,5-di-tert-butyl-4-hydroxyphenyl]propionate.

In some embodiments of the present disclosure, the crosslinkable and foamable composition may further comprise pigments. For example, the pigments may comprise, but are not limited to, azo-based type pigments, phthalocyanine-based type pigments, oxide-based type pigments, chromate-based type pigments, molybdate-based type pigments, inorganic pigments, or carbon black.

### Preparation of Crosslinkable and Foamable Composition

The crosslinkable and foamable composition of the present disclosure may be produced by using a kneading machine to first melt and blend the above-mentioned components of the hydrogenated styrene diblock copolymer, the ethylene copolymer or a combination thereof, and then incorporate the free radical initiator and the foaming agent, and other additives, such as fillers are included. Before the addition of the free radical initiator and the foaming agent, the operation is carried out below 120° C. to avoid the premature decomposition of the free radical initiator or the foaming agent.

The method of melt mixing and blending is not particularly limited, and known methods can be used. For example, an extruder such as a single-screw extruder, a twin-screw extruder, a multi-screw extruder, a Henschel mixer, a Banbury mixer, a roll mill, and a kneading can be applied to the present disclosure. In some embodiments, the melt mixing method is performed by using a kneader.

After the melt-mixing process, the shape of the crosslinkable and foamable composition of the present disclosure is not particularly limited. For instance, it may be formed into a pellet shape, a flake shape, a strand shape, or a chip shape, etc. For example, it may be mixing the components by a granulator or the like to form a pellet. For example, after kneading each component of the composition, a roll mill is used to form a sheet. Thereby, an expandable sheet, which is not crosslinked and is not foamed, will be prepared, wherein the expandable sheet comprises any one of the crosslinkable and foamable composition described above.

### Preparation of Crosslinked Foam

The crosslinkable and foamable composition provided by the present disclosure can be crosslinked and foamed to obtain the foam of the present disclosure.

The method of crosslinking and foaming is not particularly limited, and any known method may be used. Here is an example of foaming the crosslinkable and foamable composition of the present disclosure in sheet form obtained by sheeting the crosslinkable and foamable composition. The crosslinkable and foamable sheet is cut into a size in the range of 1.0 to 1.2 times the volume of the mold, and inserted it into the mold. In a typical foam molding operation, the mold is kept at about 150 to 200° C., the mold clamping pressure of 30 to 300 kgf/cm², and the holding time of 3 to 50 minutes. In the mold, the crosslinking reaction is carried out and the foaming agent is decomposed at the same time. After waiting the holding time and opening the mold, the crosslinkable and foamable composition is made into crosslinked foam. In industrial production of foam, an injection molding process of melt injecting the crosslinkable and foamable composition into a mold for crosslinking and foaming may be used.

The crosslinked foam obtained from the crosslinkable and foamable composition may have a specific gravity (also called density) from about 0.05 to 0.5 g/cm³, for example, 0.1 to 0.5 g/cm³, 0.1 to 0.45 g/cm³, 0.1 to 0.4 g/cm³, 0.1 to 0.35 g/cm³, 0.1 to 0.3 g/cm³ or 0.1 to 0.25 g/cm³. However, the present disclosure is not limited thereto, and the specific gravity of the foam may be adjusted by modifying the components of the crosslinkable and foamable composition.

The crosslinked foam obtained from the crosslinkable and foamable composition may have a hardness (Asker C) of about 30 to 80. In some embodiments where the foam is obtained from the crosslinkable and foamable composition comprising hydrogenated styrenic diblock copolymer, the foam may have the hardness (Asker C) of about, for example, 30 to 75, 30 to 70, 30 to 65, 30 to 60, 35 to 60, 35 to 55 or 40 to 55. In some embodiments where the foam is obtained from the crosslinkable and foamable composition comprising hydrogenated styrenic diblock copolymer and the ethylene copolymer, the foam may have the hardness (Asker C) of about 30 to 75, 30 to 70, 30 to 65, 30 to 60, 35 to 60, 35 to 55 or 40 to 55. However, the present disclosure is not limited thereto, and the hardness (Asker C) of the foam may be adjusted by modifying the components of the crosslinkable and foamable composition.

The crosslinked foam obtained from the crosslinkable and foamable composition may have a dry static coefficient of friction in a range of about 0.5 to 1.8, which can be determined according to ASTM D1894. In some embodiments where the foam is obtained from the crosslinkable and foamable composition comprising hydrogenated styrenic diblock copolymer, the foam may have a dry static coefficient of friction in a range of about, for example, 0.6 to 1.8, 0.6 to 1.7, 0.6 to 1.6, 0.6 to 1.5, 0.6 to 1.4, 0.7 to 1.4, 0.7 to 1.3, 0.8 to 1.3 or 0.8 to 1.0. In some embodiments where the foam is obtained from the crosslinkable and foamable composition comprising hydrogenated styrenic diblock copolymer and the ethylene copolymer, the foam may have a dry static coefficient of friction in a range of about, for example, 0.5 to 1.5, 0.5 to 1.4, 0.5 to 1.3, 0.5 to 1.2, 0.5 to 1.1, 0.5 to 1.0 or 0.5 to 0.9. However, the present disclosure is not limited thereto, and the dry static coefficient of friction of the foam may be adjusted by modifying the components of the crosslinkable and foamable composition.

The crosslinked foam obtained from the crosslinkable and foamable composition may have a wet static coefficient of friction in a range of about 0.5 to 1.5, which can be determined according to ASTM D1894. In some embodiments where the foam is obtained from the crosslinkable and foamable composition comprising hydrogenated styrenic diblock copolymer, the foam may have a wet static coefficient of friction in a range of about, for example, 0.5 to 1.4, 0.5 to 1.3, 0.5 to 1.2, 0.6 to 1.2, 0.6 to 1.1, 0.7 to 1.1, 0.7 to 1.0, 0.8 to 1.0 or 0.8 to 0.9. In some embodiments where the foam is obtained from the crosslinkable and foamable composition comprising hydrogenated styrenic diblock copolymer and the ethylene copolymer, the foam may have a wet static coefficient of friction in a range of about, for example, 0.5 to 1.4, 0.5 to 1.3, 0.5 to 1.2, 0.5 to 1.1, 0.5 to 1.0, 0.5 to 0.9, 0.5 to 0.8 or 0.5 to 0.7. However, the present disclosure is not limited thereto, and the wet static coefficient of friction of the foam may be adjusted by modifying the components of the crosslinkable and foamable composition.

The foam obtained by the crosslinkable and foamable composition of the present disclosure shows an excellent balance of mechanical properties, at least in terms of impact resilience, lightness, permanent compression set, and split tear. Thus, the foam obtained by the crosslinkable and foamable composition of the present disclosure can be widely used in automobiles, constructions, daily necessities, and sport goods as a lightweight and flexible material.

In some embodiments, the foam obtained by the crosslinkable and foamable composition of the present disclosure can be used as a component of footwear, for example, an outsole of the footwear.

In particular, when the specific gravity of foaming is decreased, the mechanical properties tend to be lowered; however, making lightweight crosslinked foam with balance mechanical properties, especially being suitable for shoe outsole or sport foam pad, in the present disclosure can be expected.

Thus, in some embodiments, the foam obtained by crosslinking and foaming the crosslinkable and foamable composition of the present disclosure may be included as a footwear component such as a shoe outsole or a sport foam pad, but the present disclosure is not limited thereto.

### Example

The present embodiment will be described in detail below referring to the examples. Nevertheless, the present embodiment is not limited to these examples. In the examples and the comparative examples, the preparation and the identification of the components used in the examples and comparative examples, and the mechanical properties evaluation of the crosslinked foams were carried out by the methods described below.

The polymer structure identification of the hydrogenated styrenic diblock copolymer is determined as follows.

### Molecular Weight and Molecular Weight Distribution

Weight average molecular weights (Mw) and number average molecular weights (Mn) were both tested and determined by gel permeation chromatography (GPC) instrument. The molecular weight value of the peak in the chromatogram was calculated by a calibration curve of commercially available standard polystyrenes. The molecular weight distribution (Mw/Mn) was determined based on the weight average molecular weights (Mw) and number average molecular weights (Mn). More detail about the testing steps and instrument information are described as below. The apparatus is commercial GPC system including PDI and refractive index detector provided by Waters Corporation. Generally, tetrahydrofuran (THF) is selected as the solvent. Measuring temperature is maintained at 40° C. The flow rate is 1 ml/min, and the injection amount is 100 μl. The ratio of hydrogenated block copolymer/THF is 3 mg/15 cc.

### Styrene Content and Vinyl Bond Content

The styrene content and the vinyl bond content of the hydrogenated styrenic diblock copolymer prior to hydrogenation are measured by ¹H-NMR spectrum employing a VARIAN 400 provided by Agilent Technologies, Inc. Generally, deuterated chloroform is selected as the solvent.

### Degree of Hydrogenation

The degree of hydrogenation may be calculated from the rate of decrease in the unsaturated bond signals in the ¹H-NMR spectrum, and the calculation is written as follows.

Degree of hydrogenation (mol %)=B/(A+B)×100%

A: Mole number of unhydrogenated conjugated diene monomer unit
B: Mole number of hydrogenated conjugated diene monomer unit

### Melt Flow Index

MFI (melt flow index) is measured according to ASTM-D1238.

Novel aspects of styrenic diblock copolymers were assessed as follows.

### Compounding Capability

An open roller mixer, provided by Hung Ta Instrument Co., Ltd. (HT-8807), is used to evaluate the compounding capability of the diblock and the triblock samples used in the Examples and Comparative examples at temperatures not exceeding 120° C. This is to simulate the footwear compounding process, which involve steps for incorporating both free radical initiator and chemical foaming agents and then for injecting the compound into press mold for foaming at temperatures that do not cause premature decomposition. The temperature is from 100 to 120° C. for not causing decomposition of free radical initiators and foaming agents.

Before the compounding process starts, the roller is heated to 120° C. Then, the sample is placed between the two rollers of the roller mixer. The material is grounded into small fragments and melted gradually to form a band. After the material is transformed from solid state to melted state, the melted polymer forms a homogeneous band attached to the rotating roller. At that time, the observation of the level of compounding difficulty and the quality of the band can be seen and determined. If the sample can't be melted well at the temperature condition, the melted surface will be uneven. At the same time, small and irregular size holes can be also observed. On the other hand, if the sample can be melted well at this temperature condition, the melted surface will be smooth and uniform.

A rating of the band formation on the roller surface is rated from 1 to 5 that a rating of 5 indicating a perfect melt film formed, while a rating of 1 indicating a poor band formation.

The mechanical properties of the crosslinked foam were evaluated as follows.

### Specific Gravity

The once crosslinked foam was punched out into a circle having a diameter of 2.54 cm and a thickness of 1 cm, and was measured by an electronic hydrometer (MS-204S, manufactured by Mettler Toledo Co., Ltd.).

### Hardness

Bases on ASTM D2240, the hardness (Asker C) of the once crosslinked foam was measured using an Asker hardness meter C hardness tester (Type C, manufactured by Polymer Co., Ltd.), and the value was read within 1 second. Also, the average value (arithmetic mean) of five points was taken as the hardness.

### Split Tear Strength

The split tear strength of the once crosslinked foam is determined according to ASTM D3574 F.

### Tensile Strength

The tensile strength at break of the once crosslinked foam is determined according to ASTM D412.

### Elongation

The elongation at break of the once crosslinked foam is determined according to ASTM D412.

### Compression Set

The once crosslinked foam was punched out into a circle having a diameter of 2.54 cm, and was used as a test piece and compressed to a thickness of 50%. After holding at 50° C. for 6 hours, the pressure was released, and the thickness after 1 hour was measured. The magnitude of the residual deformation was evaluated.

### Impact Resilience

The impact resilience of the crosslinked foam is determined according to ASTM-D2632 in a vertical rebound apparatus. Impact resilience is determined as the ratio of rebound height to drop height of a metal plunger of prescribed mass and shape which is allowed to fall on the foam specimen.

### Static Coefficient of Friction

The static coefficient of friction of the once crosslinked foam is determined according to ASTM D1894.

The resin compositions of Examples and Comparative Examples are described as follows.

### Styrenic Block Copolymers

### SEP-1: Hydrogenated Styrene-Isoprene Diblock Copolymer

SEP-1, a hydrogenated styrene-isoprene diblock copolymer, was prepared and characterized as described as follows. First, 4800 g of cyclohexane, 7.06 millimoles of n-butyllithium, and 2.66 millimoles of tetrahydrofuran (THF) were charged into a reactor of 10 liter size equipped with a heater and a stirrer. Secondly, 534 g of isoprene was added into the reactor to initiate the anionic polymerization at a temperature of about 45° C. Thirdly, 313 g of styrene was added into the reactor, and the reaction mixture was further polymerized to prepare a styrene-isoprene diblock copolymer. The 3,4-vinyl bond content in the isoprene block was about 9.1 mol %.

The styrene-isoprene diblock copolymer obtained by the above-mentioned steps was then hydrogenated in a pressure vessel using a nickel-2-ethylhexanoate/TEAL catalyst and hydrogen gas. The temperature for the hydrogenation process was controlled from about 40° C. to 100° C. After about 80 mol % of the isoprene block was hydrogenated, the hydrogenation reaction was terminated. And then, the obtained sample was washed with hot acidic water to remove residual catalyst. Finally, the block copolymer was isolated by coagulation in hot water and then dried. The yield of the hydrogenated styrene-isoprene diblock copolymer was about 80%.

According to analysis, the obtained hydrogenated styrene-isoprene diblock has a styrene content of 37 wt %, degree of hydrogenation of 80 mol % of the isoprene block, a weight average molecular weight of about 121,000, a molecular weight distribution (weight average molecular weight/number average molecular weight) of 1.03 and a MFI of 4 measured at 230° C./5 kgf.

### SEP-2: Hydrogenated Styrene-Isoprene Diblock Copolymer

SEP-2 prepared and characterized as described as follows as in the same method of preparing SEP-1, is a fully hydrogenated styrene-isoprene diblock copolymer with a styrene content of 37 wt %, in which the 3,4-vinyl bond content in the isoprene block was about 9 mol % prior to hydrogenation, and degree of hydrogenation of 99 mol % of the isoprene block. The diblock copolymer has a weight average molecular weight of about 120,000, a molecular weight distribution (weight average molecular weight/number average molecular weight) of 1.03, and MFI of 1.5 measured at 230° C./5 kgf.

### SEP-3: Hydrogenated Styrene-Isoprene Diblock Copolymer

SEP-3, prepared and characterized as described as follows as in the same method of preparing SEP-1, is a hydrogenated styrene-isoprene diblock copolymer with a styrene content of 25 wt %, in which the 3,4-vinyl bond content in the isoprene block was about 9 mol % prior to hydrogenation, and degree of hydrogenation of 84 mol % in the isoprene block. The diblock copolymer has a weight average molecular weight of about 118,000, a molecular weight distribution (weight average molecular weight/number average molecular weight) of 1.03, and a MFI of 2.2 measured at 230° C./5 kgf.

### SEP-4: Hydrogenated Styrene-Isoprene Diblock Copolymer

SEP-4, prepared and characterized as described as follows as in the same method of preparing SEP-1, is a fully hydrogenated styrene-isoprene diblock copolymer with a styrene content of 25 wt %, in which the 3,4-vinyl bond content in the isoprene block was about 9 mol % prior to hydrogenation, and degree of hydrogenation of 98 mol % in the isoprene block. The diblock copolymer has a weight average molecular weight of about 119,000, a molecular weight distribution (weight average molecular weight/number average molecular weight) of 1.03, and a MFI of 0.7 measured at 230° C./5 kgf.

### SEPS-1: Hydrogenated Styrene-Isoprene-Styrene Triblock Copolymer

SEPS-1 is a hydrogenated styrene-isoprene-styrene triblock copolymer was prepared as described as follows.

First, 4800 g of cyclohexane, 10.2 millimoles of n-butyllithium, and 2.66 millimoles of tetrahydrofuran (THF) were charged into a reactor of 10 liter size equipped with a heater and a stirrer. Secondly, 120 g styrene was added into the solvent to proceed the anionic polymerization at temperature of about 45° C. Thirdly, 560 g of isoprene was added into the reactor, until the reaction of isoprene was complete. Fourthly 120 g of styrene was added into the reactor, when the polymerization of styrene was complete, methanol was added, in order to terminate the polymerization to form a styrene-isoprene-styrene triblock copolymer structure. The styrene-isoprene-styrene triblock copolymer had the 3,4-vinyl bond content in the isoprene block was about 10 mol %.

The hydrogenation was prepared as in the same method of preparing SEP-1. According to analysis, the obtained hydrogenated styrene-isoprene-styrene triblock has a degree of hydrogenation of 78.8 mol %, styrene content of 28.8 wt %, a weight average molecular weight of about 95,000, a molecular weight distribution (weight average molecular weight/number average molecular weight) of 1.03 and MFI of 0.23 measured at 230° C./5 kgf.

### SEPS-2: Hydrogenated Styrene-Isoprene-Styrene Triblock Copolymer

SEPS-2, prepared and characterized as described as follows as in the same method of preparing SEPS-1, is a fully hydrogenated styrene-isoprene-styrene triblock copolymer with a styrene content of 28.4 wt %, in which the 3,4-vinyl bond content in the isoprene block was about 10 mol %, and degree of hydrogenation of 98.2 mol %. The triblock copolymer has a weight average molecular weight of about 95,000, a molecular weight distribution (weight average molecular weight/number average molecular weight) of 1.03 and a MFI of 0.04 measured at 230° C./5 kgf.

### EEPS-J: Hydrogenated (Butadiene/Isoprene)-Styrene Diblock Copolymer

EEPS-1, a hydrogenated (butadiene/isoprene)-styrene diblock copolymer was prepared and characterized as described as follows. First, 4800 g of cyclohexane, 7.89 millimoles of n-butyllithium, and 2.66 millimoles of tetrahydrofuran (THF) were charged into a reactor of 10 liter size equipped with a heater and a stirrer. Secondly, 295 g of isoprene and 197 g of butadiene (I/B mole ratio is controlled at 1.25) were added the same time to the reactor to initiate the anionic polymerization at a temperature of about 50° C. until the reaction of isoprene and butadiene was complete. Thirdly, 289 g of styrene was added into the reactor, when the polymerization of styrene was complete, methanol was added, in order to terminate the polymerization to form a (isoprene/butadiene)-styrene diblock copolymer. The 3,4-vinyl bond content in the isoprene block was about 13 mol % and the 1,2-vinyl bond content in the butadiene block was about 16 mol %.

The (butadiene/isoprene)-styrene diblock copolymer obtained by the above-mentioned steps was then hydrogenated in a pressure vessel using a nickel-2-ethylhexanoate/TEAL catalyst and hydrogen gas. The temperature for the hydrogenation process was controlled from about 50° C. to 90° C. Once the cumulative amount of absorbed hydrogen reached the amount corresponding to the target degree of hydrogenation, the hydrogenation reaction was terminated. And then, the obtained sample was washed with hot acidic water to remove residual catalyst. Finally, the block copolymer was isolated by coagulation in hot water and then dried. The hydrogenated styrenic diblock copolymer had a degree of hydrogenation of 78.1 mol %, a styrene content of 37.1 wt %, a weight average molecular weight (Mw) of 128,000, a molecular weight distribution (weight average molecular weight/number average molecular weight) of 1.06 and MFI of 0.63 measured at 230° C./5 kgf.

### EEPS-2: Hydrogenated (Butadiene-Isoprene)-Styrene Diblock Copolymer

EEPS-2, prepared and characterized as described as follows as in the same method of preparing EEPS-1, is a fully hydrogenated (butadiene/isoprene)-styrene diblock copolymer with a styrene content of 37.1 wt %, a degree of hydrogenation of 99.1 mol %, a weight average molecular weight (Mw) of 128,000, a molecular weight distribution (weight average molecular weight/number average molecular weight) of 1.06 and MFI of <0.1 measured at 230° C./5 kgf.

### Ethylene Copolymers

### EVA-1: Ethylene-Vinyl Acetate Copolymer

EVA-1 is an ethylene-vinyl acetate copolymer of 25 wt % vinyl acetate content and a melt flow index of 3 g/10 min as measured at 190° C./2.16 kgf, manufactured by USI Corporation, trade name “UE659”.

### Organic Peroxide

Bis(1-(tert-butylperoxy)-1-methylethyl)-benzene (BIPB) (manufactured by Arkema Group) was used.

### Chemical Foaming Agent

Azodicarbonamide (AC) (manufactured by Kumyang Corporation) was used.

### Other Additives

Calcium carbonate (manufactured by Yuncheng Chemical Industrial CO., LTD.), ZnO (Zinc Oxide, manufactured by Diamonchem Ineternational Co., Ltd.), and Stearic Acid manufactured by Vulchem Inc. were used.

### Results

Table 1 lists the polymer structure information of diblock SEP-1, diblock EEPS-1 and triblock SEPS-1, the melt flow index, and the rating of the compounding capability as measured according to the description of Compounding Capability in the above section.

TABLE 1

| | SEP-1 | SEPS-1 | EEPS-1 |
|---|---|---|---|
| Styrene content (wt %) | 37 | 28.8 | 37.1 |
| 1,2-vinyl bond, content of | — | — | 16 |
| butadiene (mol %) | | | |
| 3,4-vinyl bond, content of | 9.1 | 10 | 13 |
| isoprene (mol %) | | | |
| Hydrogenation degree | 80 | 78.8 | 78.1 |
| (mol %) | | | |
| Weight average molecular | 121K | 95K | 128K |
| weight | | | |
| MFI (230° C./5 kg) | 4 | 0.23 | 0.63 |
| Compounding rating | 5 | 1 | 5 |
| (at 120° C.) | | | |

According to the result shown in Table 1, it is clear to see that the diblock samples SEP-1 and EEPS-1 are compounded well in the roll mill compounding evaluation, forming a smooth and transparent band on the rotating roller. This is highly unexpectedly that both SEP-1 and EEPS-1 of high molecular weight and high melt viscosity as indicated from the MFI values measured at 230° C./5 kg can be compounded well. For example, diblock SEP-1 has a Mw of 121,000. In comparison, triblock SEPS-1 with a weight average molecular weight Mw of 95,000 was much difficult to compound in the roll mill, forming an opaque band on the rotating roller.

In the following examples (abbreviated as Ex) and comparative examples (abbreviated as Comp Ex), the styrenic block copolymers were mixed with the organic peroxide and foaming agent to prepare the crosslinked foam.

In Example 1, a foam composition of 100 parts by weight of SEP-1, a partially hydrogenated styrene-isoprene diblock copolymer, 0.4 part by weight of bis(1-(tert-butylperoxy)-1-methylethyl)-benzene (BIPB) based on the total weight of the resin component (herein, SEP-1), 3.0 parts by weight of azodicarbonamide (AC) based on the total weight of the resin component, 1 part by weight of zinc oxide based on the total weight of the resin component, 1 part by weight of steric acid based on the total weight of the resin component, and 10 parts by weight of calcium carbonate based on the total weight of the resin component were mixed and kneaded for 10 minutes in a roll mill having a roll surface temperature set at 120° C. Despite that SEP-1 has a weight average molecular weight of about 121,000, it was compounded well in mixing with the other ingredients of the foam formulation.

And then the compounded composition was subsequently pressurized and heated under conditions of 175° C. and 10 minutes at a pressure at 100 kgf/cm² in a press mold to obtain the crosslinked foam. Subsequently, the foam properties were determined according to the above-described methods. The results are shown in the following Table 2.

Example 2 to Example 6 were prepared and tested according to the same method as Example 1 with the exception that different polymer components and varied peroxide content were used as listed in Table 2. Examples 4 to Example 6 were based on a mixture of EVA and different styrenic-isoprene diblock copolymers resins.

In Comparative Example 1, an EVA foam was prepared and tested according to the same method as Example 1.

Comparative Example 2 to Comparative Example 5 were prepared according to the same method as Example 1 with the exception that different polymer components and varied peroxide content were used as listed in the following Table 3. Comparative Example 2 and Comparative Example 3 were based on a mixture of EVA-1 and partially hydrogenated SEPS-1 triblock and fully hydrogenated SEPS-2 triblock respectively. Comparative Example 4 and Comparative Example 5 were based on a mixture of EVA-1 and partially hydrogenated EEPS-1 diblock and fully hydrogenated EEPS-2 diblock respectively.

The results of Examples to 6 and Comparative Example 1 are shown in the Table 2 and the results of Comparative Examples 2 to Comparative Example 5 are shown in the Table 3.

TABLE 2

| | Comp | | | | | | |
|---|---|---|---|---|---|---|---|
| | Ex 1 | Ex 1 | Ex 2 | Ex 3 | Ex 4 | Ex 5 | Ex 6 |
| Formulation | | | | | | | |
| EVA-1 | 100 | — | — | 70 | 70 | 70 | 70 |
| | parts | | | parts | parts | parts | parts |
| SEP | — | SEP-1 | SEP-2 | SEP-1 | SEP-2 | SEP-3 | SEP-4 |
| | | 100 | 100 | 30 | 30 | 30 | 30 |
| | | parts | parts | parts | parts | parts | parts |
| BIPB (phr) | 0.5 | 0.4 | 0.9 | 0.5 | 0.5 | 0.5 | 0.5 |
| AC Foaming | 3.0 | 3.0 | 3.0 | 2.4 | 2.0 | 2.4 | 2.0 |
| agent (phr) | | | | | | | |
| Physical | | | | | | | |
| Properties | | | | | | | |
| Density | 0.215 | 0.204 | 0.193 | 0.218 | 0.21 | 0.228 | 0.21 |
| (g/cm³) | | | | | | | |
| Hardness | 51 | 44 | 43 | 52 | 50 | 50 | 46 |
| (Asker C) | | | | | | | |
| Static coefficient | 0.49 | 0.93 | 0.84 | 0.8 | 0.72 | 0.74 | 0.72 |
| of friction (dry | | | | | | | |
| type) | | | | | | | |
| Static coefficient | 0.46 | 0.84 | 0.72 | 0.68 | 0.6 | 0.64 | 0.6 |
| of friction (wet | | | | | | | |
| type) | | | | | | | |
| Split Tear | 2.75 | 2.02 | 1.86 | 2.82 | 3.63 | 2.57 | 3.47 |
| (kgf/cm) | | | | | | | |
| Compression Set | 59 | 45 | 48 | 56 | 67 | 54 | 65 |
| (%) | | | | | | | |
| Impact resilience | 55 | 51 | 50 | 55 | 53 | 57 | 55 |
| (%) | | | | | | | |
| Shrinkage | 4 | 2 | 2 | 2 | 2 | 2.5 | 2.5 |
| (%) | | | | | | | |
| Tensile Strength | 29.2 | 34 | 32.9 | 38.4 | 37 | 40.7 | 38.5 |
| (Kgf/cm²) | | | | | | | |
| Elongation | 196 | 285 | 261 | 264 | 277 | 320 | 338 |
| (%) | | | | | | | |

TABLE 3

| | Comp | Comp | Comp | Comp |
|---|---|---|---|---|
| Formulation | Ex 2 | Ex 3 | Ex 4 | Ex 5 |
| EVA-1 | 70 parts | 70 parts | 70 parts | 70 parts |
| SEC | SEPS-1 | SEPS-2 | EEPS-1 | EEPS-2 |
| | 30 parts | 30 parts | 30 parts | 30 parts |
| BIPB (phr) | 0.5 | 0.5 | 0.5 | 0.6 |
| AC Foaming agent (phr) | 3.0 | 3.0 | 3.0 | 3.0 |
| Physical Properties | | | | |
| Density (g/cm³) | 0.2 | 0.19 | 0.27 | 0.213 |
| Hardness (Asker C) | 47 | 43 | 56 | 51 |
| Static coefficient of friction | 0.63 | 0.63 | 0.53 | 0.56 |
| (dry type) | | | | |
| Static coefficient of friction | 0.59 | 0.56 | 0.51 | 0.53 |
| (wet type) | | | | |

Comparative Example 1 serves to compare the anti-slip performance with the Examples 1 to 6 comprising styrenic-isoprene diblock copolymers. As shown in Table 2, all the foams of Examples 1 to 6 show superior anti-slip property than the EVA-1 foam of Comparative Example 1. In addition, all the foams of Comparative Example 2 to Comparative Example 5 all show poorer anti-slip property than the foams of Example 3 to Example 6. These results indicate that the foams prepared by the composition comprising the styrenic-isoprene diblock copolymers have improved anti-slip property.

In conclusion, the present disclosure provides a crosslinked foam obtained by the crosslinkable and foamable composition comprising the hydrogenated styrene-isoprene diblock copolymer of the present disclosure, or a blend of the hydrogenated styrene-isoprene diblock copolymer of the present disclosure and the ethylene copolymer. The crosslinked foam of the present disclosure shows superior anti-slip property, and an excellent balance of mechanical properties, at least in terms of impact resilience, lightness, permanent compression set, and split tear. Moreover, the crosslinked foam can be suitably used as various molded articles such as shoe midsole and outsole, automotive parts, civil engineering and construction applications, household appliance parts, sporting goods, as well as in a wide range of other fields. In particular, the crosslinked foam attains excellent anti-slip property, which is an important feature for footwear outsole applications.

Although the present disclosure has been explained in relation to its embodiment, it is to be understood that many other possible modifications and variations can be made without departing from the spirit and scope of the disclosure as hereinafter claimed.

What is claimed is:

1. A crosslinkable and foamable composition, comprising a hydrogenated styrenic diblock copolymer, a free radical initiator, and a foaming agent, wherein the hydrogenated styrenic diblock copolymer comprises:
a first block comprising an isoprene unit; and
a second block comprising a styrene unit,
wherein the hydrogenated styrenic diblock copolymer comprises 10 to 60 wt % of the styrene unit, 50 mol % or more of the isoprene unit is hydrogenated, and the hydrogenated styrenic diblock copolymer has a weight average molecular weight of 30000 to 200000.

2. The crosslinkable and foamable composition of claim 1, wherein the first block is a polymer block of the isoprene unit and the second block is a polymer block of the styrene unit.

3. The crosslinkable and foamable composition of claim 1, wherein the first block is a polymer block of the isoprene unit and a butadiene unit, wherein a content of the butadiene unit is less than or equal to 15 wt % based on a total weight of the first block, and the second block is a polymer block of the styrene unit.

4. The crosslinkable and foamable composition of claim 1, wherein the first block is a polymer block of the isoprene unit, and the second block is a polymer block of the styrene unit and a conjugated diene monomer unit, wherein the conjugated diene monomer unit is a butadiene unit, an isoprene unit, or a mixture thereof, and a content of the conjugated diene monomer unit is less than or equal to 15 wt % based on a total weight of the second block.

5. The crosslinkable and foamable composition of claim 1, wherein the first block is a polymer block of the isoprene unit and a butadiene unit, wherein a content of the butadiene unit is less than or equal to 15 wt % based on a total weight of the first block, and the second block is a polymer block of the styrene unit and a conjugated diene monomer unit, wherein the conjugated diene monomer unit is a butadiene unit, an isoprene unit, or a mixture thereof, and a content of the conjugated diene monomer unit is less than or equal to 15 wt % based on a total weight of the second block.

6. The crosslinkable and foamable composition of claim 1, wherein a 3,4-vinyl bond content in the isoprene unit is in the range of 5 to 40 mol % prior to hydrogenation.

7. The crosslinkable and foamable composition of claim 1, wherein 60 to 100 mol % of the isoprene unit is hydrogenated after hydrogenation.

8. The crosslinkable and foamable composition of claim 1, wherein the free radical initiator is an organic peroxide, wherein the organic peroxide, is selected from the group consisting of dicumyl peroxide, bis(1-(tert-butylperoxy)-1-methylethyl)-benzene, and a combination thereof.

9. The crosslinkable and foamable composition of claim 1, wherein the foaming agent is a chemical foaming agent, wherein the chemical foaming agent is azodicarbonamide.

10. The crosslinkable and foamable composition of claim 1, further comprising a crosslinking co-agent.

11. A crosslinkable and foamable composition of claim 1, further comprising an ethylene copolymer, wherein a weight ratio of the ethylene copolymer to the hydrogenated styrenic diblock copolymer is from 50/50 to 95/5.

12. The crosslinkable and foamable composition of claim 11, wherein the ethylene copolymer comprises an ethylene-vinyl acetate copolymer, an ethylene-α-olefin copolymer or a combination thereof.

13. The crosslinkable and foamable composition of claim 11, wherein the ethylene copolymer is an ethylene-vinyl acetate copolymer, and a content of vinyl acetate is in a range of 15 to 40 wt % based on a total weight of the ethylene copolymer.

14. The crosslinkable and foamable composition of claim 11, further comprising a crosslinking co-agent.

15. A foam obtained by crosslinking and foaming a crosslinkable and foamable composition of claim 1.

16. The foam of claim 15, wherein the foam has a specific gravity of 0.1 to 0.5 g/cm³, a dry static coefficient of friction in a range of 0.6 to 1.8, a wet static coefficient of friction in a range of 0.5 to 1.5, and a hardness in a range of 30 to 80.

17. The foam of claim 15, which is a component of footwear.

18. The foam of claim 17, which is an outsole of the footwear.

19. A foam obtained by crosslinking and foaming a crosslinkable and foamable composition of claim 11.

20. The foam of claim 19, wherein the foam has a foam density of 0.1 to 0.5 g/cm³, a dry static coefficient of friction in a range of 0.5 to 1.5, a wet static coefficient of friction in a range of 0.5 to 1.2, and a hardness in a range of 30 to 80.

21. The foam of claim 19, which is a component of footwear

22. The foam of claim 21, which is an outsole of the footwear.

23. A composition for foaming, comprising a hydrogenated styrenic diblock copolymer, wherein the hydrogenated styrenic diblock copolymer comprises:
a first block comprising an isoprene unit; and
a second block comprising a styrene unit,
wherein the hydrogenated styrenic diblock copolymer comprises 10 to 60 wt % of the styrene unit, 50 mol % or more of the isoprene unit is hydrogenated, and the hydrogenated styrenic diblock copolymer has a weight average molecular weight of 30000 to 200000.

24. The composition of claim 23, further comprising an ethylene copolymer.

25. A use of the composition of claim 23, for preparing a foam.
